(19) United States
(12) Patent Application Publication
(10) Pub. No.: US 2007/0206536 A1
(43) Pub. Date: Sep. 6, 2007

(54) Autoconfiguration of wireless networks

(76) Inventors: David Abusch-Magder, Maplewood, NJ (US); Harish Viswanathan, Morristown, NJ (US)

Correspondence Address: HARNESS, DICKEY & PIERCE, P.L.C., P.O. BOX 8910, RESTON, VA, 20195, US

(21) Appl. No.: 11/368,289

(22) Filed: Mar. 3, 2006

(51) Int. Cl. H04Q 7/24; H04J 3/22; H04J 3/16; H04Q 7/00

(52) U.S. Cl. 370/331; 370/465; 370/338

(57) ABSTRACT

The autoconfiguration of a base station in a wireless communication network is accomplished using data received from network subscribers. This subscriber data is used to determine suitable values for base station parameters that require cooperation between or among base stations and subscribers. For example, the PN offset of this base station is determined using interference data obtained from subscribers.

### TECHNICAL FIELD

This invention relates to wireless communication networks and, in particular, to management of wireless communication networks.

### BACKGROUND OF THE INVENTION

A wireless network generally is divided into a multiplicity of cells with each cell having at least one base station. A user within the cell wishing to send information establishes communication with a base station in the cell. This receiving base station communicates typically with a mobile switching center, another base station, or other network entity that, in turn, relays the information through the network to another base station or network, e.g. public switch telephone network or internet, where the intended recipient is located.

The efficient use of such network requires a multiplexing scheme in which communication from numerous users (often as many as 200 users per cell) are being handled simultaneously. Similarly, each mobile at times receives a decodable signal from more than 1 base station (typically 3, sometimes 6 or more). A variety of protocols has been developed to achieve such goals. Generally, in accordance with the protocol being employed, identification and operation parameters are assigned to each base station and to each user. For example, in one approach to a code division multiplexing access (CDMA) network base stations are identified by a pseudo random noise (PN) sequence offset. That is, transmission in such a CDMA system from each base station over a pilot channel (a channel used for supporting the network operation and generally not as a primary conveyance channel of network traffic) is divided into cycles following a predetermined pseudo random noise pattern. The PN cycle repeats in 26-⅔ millisecond intervals, with each interval consisting of 2¹⁵ chips, with each chip having a timing interval of 0.813 microseconds. An interval of 2¹⁵ chips each is divided, in turn, into 512 valid PN offsets that are separated by 64 chips each (52 microseconds). A base station identifies itself by transmitting on the pilot channel with the pseudo random noise pattern beginning at an assigned PN offset. Users wishing to initiate communication search for a signal on a pilot channel and identify a base station for such communication by the PN offset of the sensed pilot channel transmission. Other protocols such as universal mobile telecommunication (UTMS) have their own identification parameters such as scrambling codes (see WCDMA for UTMS, Ed. Holma and Toskala, 2002 2^{nd} Ed. Wiley & Sons).

Operating parameters, in addition to identification parameters, are also an essential part of network management. Within any discrete geographic region the base stations present are assigned a limited number of carrier frequencies. Suitable choice of many other operating parameters is also important. The transmission intensity of a base station or of an individual user often has a profound effect on both 1) the interference generated for other base stations or users who are not the intended receiver of the transmission as well as 2) the probability of transmission reception by the intended receiver. A variety of other operating parameters such as antenna orientation, hand-off thresholds, traffic power limits, and pilot power fraction of total amplifier power similarly affect network function.

In establishing a communications network operating and identification parameters are set for each base station—often numbering as many as 1000 base stations for a metropolitan area. Thus significant planning associated with parameters typically precedes such establishment. Although at least some of these parameters are adjusted as the network evolves, the incipient choices are carefully made to avoid initial network failure or to avoid an excessive duration and/or area of unacceptable operation. Even after a network is operating, further base stations are added as the network expands. Such additional base stations have identification and operating parameters that require initialization. A poor initial choice of parameters has the potential for causing network failure or unacceptable degradation.

The efforts and concomitant costs associated with planning, initializing and/or expanding a network are substantial. Significantly, there is an accelerating growth trend in the number and density of cells in wireless networks. Accordingly, the fraction of revenues service providers expend on configuring and planning their networks is expected to grow. The situation is further aggravated as demand for higher bandwidth services increases and as wireless data and voice services become ubiquitous. For example in-building services, high speed data hotspots, and the use of cells with relatively small geographic boundaries (often denominated pico-cells) for video and gaming application are becoming commonplace.

One proposed approach for controlling expenditures is autoconfiguration. In such procedures upon initialization a base station automatically establishes some or all of its own identification and operations parameters. Although the goal of autoconfiguration is alluring, these procedures are in their infancy. Therefore, any expedient that enhances autoconfiguration efficiency is quite useful.

### SUMMARY OF THE INVENTION

It has been found that the use of subscriber gathered data to initialize specifically chosen parameters has a meaningful, salutary effect on the efficiency of an autoconfiguration process. In particular subscriber data is applied to establish cooperation parameter(s), i.e. an operational and/or identification base station parameter specified in a standard and whose value when chosen is conveyed to at least one subscriber for operation of the primary communication channel. (A parameter is specified in a standard when a network operator in complying with the standard is not free to choose any value it desires for such parameter. Conveyance of the value of such parameter to a subscriber occurs when the subscriber or the subscriber's transceiver receives information from which the parameter value is derivable with or without other further information.) Exemplary of cooperation parameters are base station PN offset, traffic channel power, handoff threshold, and maximum neighbor list length.

As discussed, subscriber gathered data is employed to adjust at least one of the cooperation parameters during autoconfiguration. (A subscriber is considered for purposes of this invention a user of the network that provides a consideration to the network provider for use of the network.) Subscriber data is that information derived from transmissions of a subscriber. For example, in one embodiment of the invention a subscriber's transceiver notes the time and location of unintended cessation of communication, for example, when traversing a geographic service dead spot. After passing the dead spot, in this example, the subscribers transceiver transmits the noted time and location to the network where this subscriber information is stored at a network asset, e.g. MSC or operation and management server.

Generally, at least one subscriber data point from each of at least 20 subscribers, preferably 100 subscribers, most preferably 300 subscribers are employed for adjusting cooperation parameter(s) during autoconfiguration. Subscribers are easily differentiated by their identification parameter, i.e. mobile identification number. Data points are distinguished from each other by being separated in the time of data observation by at least 10 sec and/or by being separated in the location of data observation by at least 10 meters. By use of subscriber data to adjust cooperation parameters during autoconfiguration advantageous results are achievable. However, although use of subscriber data has been described in the context of autoconfiguration, its use is also quite advantageous in any adjustment of network operation.

### BRIEF DESCRIPTION OF THE DRAWINGS

FIG. 1 is an illustrative wireless network amenable to autoconfiguration of base stations;

FIG. 2 is a flow diagram exemplary of steps possible in relation and embodiment of the invention; and

FIG. 3 is a flow diagram exemplary of another aspect of the invention.

### DETAILED DESCRIPTION

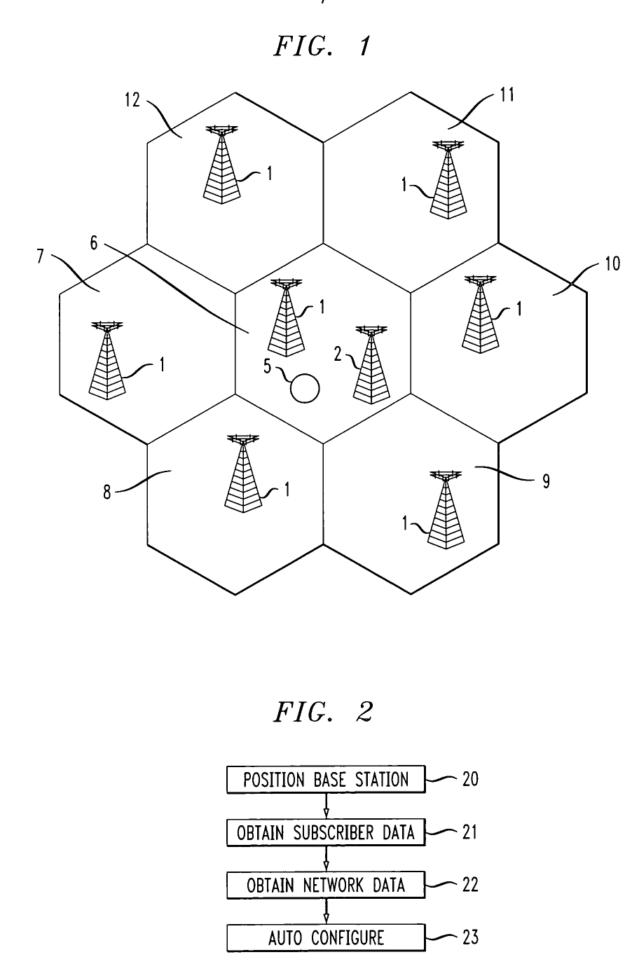

Autoconfiguration techniques are employable in establishing a network and/or in adding base stations to an existing network. For pedagogic purposes this description is in terms of the addition of a base station. However, the same procedure is employed for 1) autoconfiguring the multiplicity of base stations involved in initially establishing a network or a portion of a network or for 2) reassigning parameters when a base station is relocated or its service changes significantly. Generally such network includes cells, 6 through 12, with each cell having at least one base station 1 in FIG. 1. As previously discussed a user, 5, communicates with a base station within the same cell and that base station in turn continues communication with the network. In the autoconfiguration of a new base station such as base station 2 in FIG. 1, the base station is first geographically positioned as noted at 20 in the flow chart of FIG. 2.

The base station parameters are then initialized. Such initialization is performed using both subscriber data and network data. Network data, as the term is employed in this description, is information that is stored within the network, for example, at a base station or operations and management server and that has been s gathered from sources other than subscribers. Thus, for example, at a MSC there is generally stored a list of existing base stations, the carrier frequency in use by each base station, and the PN offset for each existing base station. Such information is obviously maintained by a network provider during the normal course of business and is compiled by such provider.

Network data also includes information gathered by a base station automatically or through the intervention of a person such as an employee of a network operator acting in a non-subscriber capacity. Exemplary of such network data is interference levels monitored by a base station during operation. Thus, it is possible for a base station to receive from the network the transmitted power level of other base stations at a specific time and to correlate that information with its own transmitted power level at that time. Accordingly, as indicated at 22 in FIG. 2 the positioned base station before or during autoconfiguration determines network data, e.g. carrier frequencies and PN offsets for base stations in its geographic vicinity, or possibly within its network.

In accordance with the invention before or during autoconfiguration the base station being configured also obtains subscriber data as indicated at 21 in FIG. 2. This subscriber data has two categories. In the first category, information is derived from the properties of the signal transmitted by the subscriber. Thus the SINR of a subscriber's signal to the base station and the location of the subscriber at the time of such transmission, possibly correlated with the signal strength of other base stations in the vicinity are exemplary of such derived subscriber information. (A neighbor list is exemplary of a list of proximate base stations and is a compilation that associates with a first base station other neighboring base stations that transmit signals whose information is discernible by subscribers positioned to communicate with the first base station. The term signal-to-interference-and-noise ratio is commonly used and is defined in J. S. Lee and L. E. Miller, CDMA Systems Engineering Handbook, Artech House, Boston 1998, p. 1082.) In another example geographic distribution of subscriber traffic is derivable from subscriber signals. Such category one information is storable, for example, at an MSC, operation and management server or at the base station to be configured.

In the second category subscriber information includes data taken and transmitted by the subscriber. For example, in one embodiment of the invention, a subscriber's transceiver is programmed to note and store the geographic location where a base station signal is not detectable. After moving from this location to a subsequent position where communication with a base station is possible, the subscriber transmits the previously detected and stored outage data to the network. It is possible for such received subscriber information to be stored in any location in the network provided such information is subsequently retrievable. Thus such category two information is storable at, for example, an MSC, operation and management server or at the base station that is to be autoconfigured.

In another embodiment, subscriber information is derivable by programming a subscriber's transceiver to function as a sensor during times that it has not established a communication channel. Accordingly, during such periods of communication inactivity the subscriber's transceiver monitors the SINR of signals it is receiving from adjacent base stations, e.g. subscriber 5 in FIG. 1 monitors the signal from operating base stations in cells 6 through 12. This data together with the subscriber's location is then transmitted at a convenient time to the network for use and/or storage. Even when such a subscriber is in a sensor mode at a location where communication information is not decodable, it is still possible to extract broadcast control and synchronization information from base station transmissions by increasing the integration time such a subscriber provides to the reception of such signals. In addition to the possibility of transmitting the captured subscriber data during conventional communications with a base station it is alternatively feasible to transmit such subscriber data at very low data rates, (e.g. burst rates less than 1 Kbit per second) on a separate access channel with increased integration time for such sensor mode operation.

With the addition to many networks of cells that are confined to indoor location such as a building, other subscriber data relating to such locations is also quite useful for autoconfiguration processes. In particular a subscriber notes its location and whether such location is in a confined area or an open area. (For purposes of this invention a confined area is defined as one having a cover to the elements.) This information, as other subscriber information, is transmitted to the network for use in autoconfiguration since such data provides a sense of in/outdoor distribution of traffic that has potential usefulness in autoconfiguration.

Another form of subscriber information involves the detection of collisions, i.e. unacceptable interference among and/or between base stations. In one embodiment, a subscriber notes the presence of more than one transmission having the start of a pseudo random noise pattern within a given detection window e.g. a 64-chip window. The subscriber using, for example, software embedded in its transceiver determines if the coincidence is due to multipath interference (e.g. from a reflected signal) or from a collision of two distinct signals. This determination is then conveyed to the network or to a base station undergoing autoconfiguration. Alternatively, the subscriber notes data relative to the coincidence and transmits that data to the network or an autoconfiguring base station for analysis.

Reporting of subscriber information to the network is possible in a variety of modes. In one embodiment a base station such as the base station to be autoconfigured or another base station sends out a request for such data to the subscribers in its transmission reception area. The subscribers then respond with a transmission of their collected data. Alternatively such signal can trigger the collection of requested data and its reporting to and/or subsequent storage in the network. In another embodiment, subscribers periodically report the data to the network, for example, at a much lower transmission rate than during an active call. In yet another embodiment, transmission of subscriber information is triggered by certain conditions experienced by the subscriber. For example, the subscriber transmits such information when located at specific geographic positions and/or when received base station signals are at particularly strong levels. In this manner, a base station to be configured through the network requests specific types of targeted data that are useful to make a particular autoconfiguration decision. Previous acquisition and storage of such data or acquisition in response to the process of autoconfiguration is useful.

To facilitate the reception of subscriber data by a base station before the base station is autoconfigured, it is possible to set aside a limited number of identification parameters. These reserved identification parameters are designated by the network operator for use in autoconfiguration rather than for primary communication. A base station before autoconfiguration identifies itself using one or more of the reserved identification parameters to initiate communication for the purpose of requesting and/or receiving subscriber data. Since a reserved identification parameter is employed, interference with the primary communication of other base stations is avoided. Exemplary of reserved identification parameters are PN offset and/or carrier frequency for CDMA systems, time slot for time division multiplexing systems, and scrambling code for UTMS systems. The number of parameters reserved should not unacceptably limit network capacity. Generally less than 5% of the total identification parameters are reserved.

The subscriber data with, if desired, network data, is applied to establish at least one cooperation parameter during autoconfiguration at step 23 in FIG. 2. The subscriber data employed during autoconfiguration should encompass at least one data point obtained from each of at least 20 distinct subscribers—subscribers with different identification numbers. One data point is distinguished from another by being separated in the time of data observation by at least 10 seconds and/or being separated in the location of data observation by at least 10 meters. Use of subscriber data is particularly valuable since it is taken under circumstances typical to the usage of such subscribers. Thus employing more subscriber data although not essential is generally advantageous. In one advantageous embodiment at least 100 data points, preferably at least 1000 data points, most preferable at least 10,000 data points are employed. Similarly, the number of subscribers associated with such data is not limited to 20. In one embodiment at least 20, preferable at least 100, most preferably at least 300 subscribers are associated with the subscriber data being used.

As previously discussed the data used during autoconfiguration in one embodiment is stored in the network. For example, the storage facility is a server located at a network facility such as a MSC or an operations and management server. Alternatively, the data is storable at least in part, at a base station possibly the one to be autoconfigured. In another approach, the subscribers store the information and transmit such information upon a triggering event or when requested by the network and/or by the base station to be autoconfigured.

Much of the discussion has centered on autoconfiguration of a base station within a network. Nevertheless, the cooperative interaction of base stations is employable to enhance the operation of the network using the autoconfiguration process. After such autoconfiguration of a specific base station, the quality of network operation is measurable using a figure of merit such as dropped call percentage, lost call percentage, or average SINR. If this figure of merit is acceptable, then no further adjustment is needed.

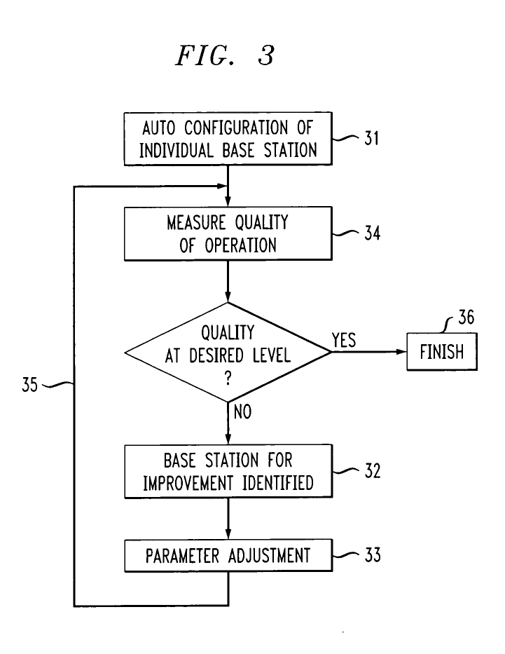

Alternatively, if further improvement in network configuration is desirable, then an associated cooperative interaction between base stations is advantageous. In a first step, 31 in FIG. 3, base station(s) including a primary base station are autoconfigured, for example, by the procedure of the invention. The operation quality of a plurality of base stations within the network is measured, 34, as discussed previously. Based on a selection criterion, a base station is chosen to be adjusted. For example, the base station, (other than the primary), with the poorest figure of merit is identified at 32. This base station is adjusted, e.g. reconfigured, for example, by the autoconfiguration procedure of this invention, to improve operation in the context of network operation. Accordingly, operation and/or identification parameters are adjusted, 33, to improve the network figure of merit.

In a cyclic iteration, 35, a figure of merit is again determined at 34. If operation is at a desired level further immediate adjustment of parameters is not performed and the procedure terminates at 36. However, if further improvement is desired a screening criterion is again used to determine the next base station for consideration. For example, the screening criterion has depending on the embodiment, broad aspects and/or specific aspects. In the broad aspect, screening criteria are exemplified by 1) limiting the next base station to be reconfigured to one that has a relatively high power level, or 2) excluding from reconfiguration base stations that carry at relatively high traffic density. In the former case, base stations are considered for reconfiguration that have the greatest potential for causing interference. In the latter case, base stations whose reconfiguration have the potential for serious disruption to the network are excluded. Exemplary of specific screening criteria are 1) reconfiguring the base station that has the lowest figure of merit and/or 2) not considering for reconfiguration base stations that have been reconfigured during the current set of cycles. Thus in one embodiment of screening criterion application the base station showing the next least desirable figure of merit is identified, 32, and its operation and/or identification parameters adjusted using, for example, subscriber data and if desired network data.

The cycle, 35, including determining quality and adjusting parameters of the base station with next least desirable operation is continued until the desired level of operation is achieved or the work associated with further adjustment is not deemed justified.

The described cyclic adjustment procedure in one embodiment is simplified by considering only a fraction of the network base stations for parameter adjustment. This management of the adjustment process is accomplished by first measuring the received transmission power of network base stations to be considered for parameter adjustment. A fraction of these base stations correlated to the corresponding fraction of most powerful base stations are then further considered in the cyclic process of FIG. 3.

1. A process of autoconfiguring a base station as part of a wireless communication network including additional base stations, said process comprising, 1) obtaining subscriber data from at least 20 subscribers including at least one data point from each of said 20 subscribers, 2) using said subscriber data to set at least one cooperation parameter, and 3) employing said cooperation parameter to operate said base station.

2. The process of claim 1 wherein said wireless communication network is a CDMA wireless communication network.

3. The process of claim 1 wherein said cooperation parameter comprises a PN offset.

4. The process of claim 1 wherein said cooperation parameter comprises a handoff threshold.

5. The process of claim 1 wherein said cooperation parameter comprises a neighbor list.

6. The process of claim 1 wherein said cooperation parameter is set using network data and said subscriber data.

7. The process of claim 6 wherein said network data comprises interference levels monitored by said base station.

8. The process of claim 1 wherein said subscriber data comprises geographic distribution of subscriber traffic.

9. The process of claim 1 wherein said subscriber data comprises a geographic location at which at least one of said subscribers was unable to detect a signal from said additional base stations or from said base station.

10. The process of claim 8 wherein said subscriber data is transmitted to said network by at least one of said subscribers after moving from said location.

11. The process of claim 1 wherein said subscriber data comprises the SINR of a signal that undergoes reception by at least one of said subscribers from at least one of said additional base stations.

12. The process of claim 11 wherein said at least one of said subscribers transmits said subscriber data to said network at a time remote from said reception.

13. The process of claim 1 wherein said subscriber data is transmitted to said network by at least one of said subscribers at a burst rate less than 1 Kbit/sec.

14. The process of claim 1 wherein said subscriber data comprises the geographic location of a confined area.

15. The process of claim 1 wherein said subscriber data comprises the geographic location or the traffic distribution in a confined area.

16. The process of claim 1 wherein said subscriber data comprises the location of unacceptable interference between two of said additional base stations.

17. The process of claim 1 wherein said subscriber data is obtained from at least one of said subscribers in response to a request from said base station.

18. The process of claim 1 wherein said subscriber data is transmitted from at least one of said subscribers upon occurrence of a predetermined event.

19. The process of claim 18 wherein said event comprises location of said at least one of said subscribers at a predetermined location.

20. The process of claim 1 wherein said subscriber data is obtained by communication with said base station such that said base station employs a reserved identification parameter to facilitate said communication of said subscriber data.

21. The process of claim 20 wherein said reserved identification parameter comprises a PN offset.

22. The process of claim 20 wherein said reserved identification parameter comprises a communication time slot.

23. The process of claim 20 wherein said reserved identification parameter comprises a carrier frequency.

24. The process of claim 1 wherein said subscriber data is obtained from at least 100 of said subscribers.

25. The process of claim 24 wherein said subscriber data is obtained from at least 300 of said subscribers.

26. The process of claim 24 wherein said subscriber data comprise at least 1000 data points.

27. The process of claim 26 wherein said subscriber data comprise at least 10,000 data points.

28. The process of claim 1 further comprising determining after said autoconfiguration a figure of merit for a plurality of said additional base stations of said network, choosing as a target base station for adjustment one of said additional base stations in accordance with a selection criterion, and adjusting at least one operational or identification parameter of said target base station to improve said figure of merit.

29. The process of claim 28 wherein said choosing of a target base station and adjusting of parameters continues cyclically.

30. The process of claim 28 wherein said selection criterion comprises excluding base stations that serve a relatively large number of users.

31. The process of claim 28 wherein said selection criterion comprises excluding base stations that have already been reconfigured.

32. The process of claim 28 wherein said selection criterion comprises selecting as said target base station for adjustment one of said additional base IS stations with said figure of merit poorer relative to other of said additional base stations.

33. The process of claim 1 wherein said subscriber data is communicated to said base station through said network.

34. A process of adjusting at least one base station as part of a wireless communication network including a plurality of base stations, said process comprising 1) obtaining subscriber data from at least 20 subscribers including at least one data point from each of said 20 subscribers, 2) using said subscriber data to adjust at least one cooperation parameter of at least one of said base stations, and 3) employing said base station with said cooperation parameter that has been adjusted to communicate over said network.

35. The process of claim 34 wherein said subscriber data comprises geographic distribution of subscriber traffic.

36. The process of claim 34 wherein said subscriber data comprises a geographic location at which at least one of said subscribers was unable to detect a signal from at least one of said base station.

37. The process of claim 36 wherein said subscriber data is transmitted to said network by at least one of said subscribers after moving from said location.

38. The process of claim 34 wherein said subscriber data comprises the SINR of a signal that undergoes reception by at least one of said subscribers from at least one of said base stations.

39. The process of claim 38 wherein said at least one of said subscribers transmits said subscriber data to said network at a time remote from said reception.

40. The process of claim 34 wherein said subscriber data comprises the geographic location of a confined area.

41. The process of claim 34 wherein said subscriber data comprises the location of unacceptable interference between two of said base stations.

42. The process of claim 34 wherein said subscriber data is obtained from at least one of said subscribers in response to a request from at least of one said base stations.

43. The process of claim 34 wherein said subscriber data is data transmitted from at least one of said subscribers upon occurrence of a predetermined event.

44. A process for autoconfiguring of a wireless communication network including a plurality of base stations, said process comprising the steps of autoconfiguring at least one of said base stations, determining after said autoconfiguration a figure of merit for the remainder of said plurality of base stations, choosing at least one of said base station for adjustment based on a selection criterion, adjusting at least one operation or identification parameter of said base station.

45. The process of claim 44 wherein said choosing said at least one of said base station for adjustment and adjusting of parameters continues cyclically.

46. The process of claim 44 wherein said figure of merit comprises percentage of dropped calls.

47. The process of claim 44 wherein said identification parameter comprises a PN offset.

48. The process of claim 44 wherein said selection criterion comprises including base stations that have already been adjusted.

49. The process of claim 44 wherein said selection criterion comprises selecting as said base station for adjustment one of said base stations with said figure of merit poorer relative to other of said base stations.
